(19) United States
(12) Patent Application Publication
(10) Pub. No.: US 2024/0369436 A1
(43) Pub. Date: Nov. 7, 2024

(54) PRESSURE SENSOR

(71) Applicant: NIDEC COMPONENTS CORPORATION, Tokyo (JP)

(72) Inventors: Masaki Fukasawa, Sano-shi (JP); Yusuke Ishikawa, Sano-shi (JP)

(73) Assignee: NIDEC COMPONENTS CORPORATION, Tokyo (JP)

(21) Appl. No.: 18/775,106

(22) Filed: Jul. 17, 2024

Related U.S. Application Data
(63) Continuation of application No. PCT/JP2022/043328, filed on Nov. 24, 2022.

(30) Foreign Application Priority Data
Jan. 20, 2022 (JP) 2022-007316

(51) Int. Cl. G01L 19/06

(52) U.S. Cl. CPC G01L 19/0645; G01L 19/0681

(57) ABSTRACT

Embodiments provide a pressure sensor capable of surely filling inside of a housing in which an adjustment member is provided with insulating liquid. A base includes a first flow path to be filled with a first fluid and a first recess communicating with the first flow path. A first diaphragm seals the first recess. A sensor unit is provided in the first recess. An adjustment member is arranged around the sensor unit in the first recess, communicates with the first flow path, and includes a hole introducing the first fluid in the first flow path into the first recess. The first diaphragm includes a plurality of grooves arranged concentrically, and the hole is opposed to one of the plurality of grooves.

### CROSS-REFERENCE TO RELATED APPLICATIONS

This application is a Continuation Application of PCT Application No. PCT/JP2022/043328, filed Nov. 24, 2022 and based upon and claiming the benefit of priority from prior Japanese Patent Application No. 2022-007316, filed Jan. 20, 2022, the entire contents of all of which are incorporated herein by reference.

### BACKGROUND OF THE INVENTION

### 1. Field of the Invention

The present invention relates to a pressure sensor detecting, for example, fluid such as gas or liquid.

### 2. Description of the Related Art

In a pressure sensor detecting gas or liquid, a housing including a diaphragm is bonded to a base including a sensor chip, and the inside of the housing is filled with insulating liquid (for example, refer to JP 3370593 B). Insulating liquid affects temperature property of the pressure sensor. Thus, an adjustment member adjusting the amount of liquid is provided inside housing (for example, refer to JP H10-122997 A and JP 2019-132817 A).

### BRIEF SUMMARY OF THE INVENTION

In association with downsizing of a pressure sensor, a space filled with insulating liquid becomes narrower. Thus, it is necessary to surely fill inside housing in which the adjustment member is provided with insulating liquid.

The embodiments of the present invention provide the pressure sensor surely filling inside of the housing in which the adjustment member is provided with insulating liquid.

A pressure sensor of a present embodiment comprises a base including a first flow path filled with a first fluid and a first recess communicated with the first flow path, a first diaphragm sealing the first recess, a sensor unit provided in the first recess, and an adjustment member that is arranged around the sensor unit in the first recess, communicated with the first flow path, and including a hole introducing the first fluid in the first flow path into the first recess. The first diaphragm includes a plurality of grooves arranged concentrically, and the hole is opposed to one of the plurality of grooves.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a top view showing a pressure sensor of a present embodiment.

FIG. 2 is a perspective view of FIG. 1.

FIG. 3 is an exploded perspective view of FIG. 1.

FIG. 4 is a cross-sectional view along line IV-IV in FIG. 1.

FIG. 5 is a cross-sectional view along line V-V in FIG. 1.

FIG. 6 is an expanded sectional view showing portion A in FIG. 5 from oblique direction.

### DETAILED DESCRIPTION OF THE INVENTION

Hereinafter, embodiments are explained with reference to accompanying drawings. In the figures, the same portions or portions having same function are given the same reference symbols.

### Advantage of Embodiment

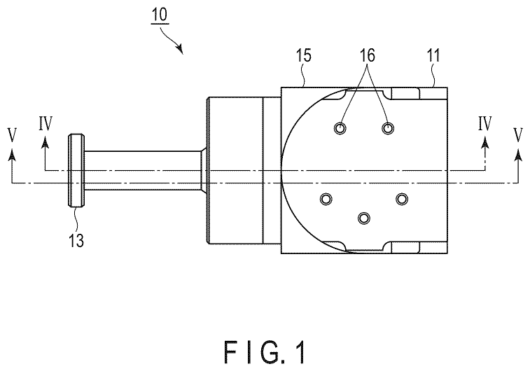

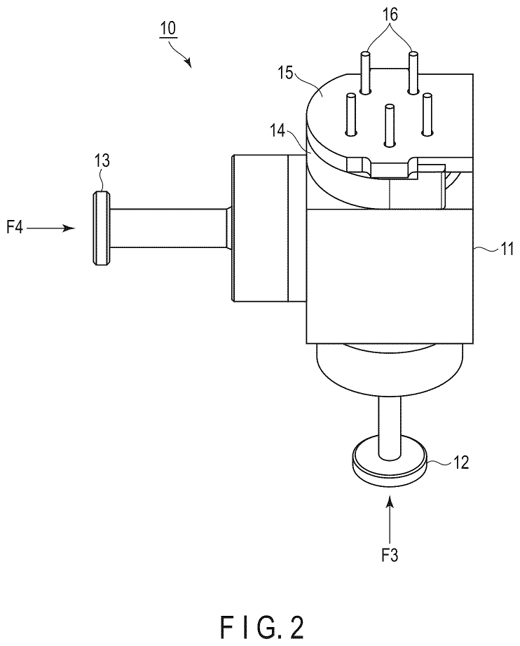

FIG. 1 to FIG. 6 show a pressure sensor 10 of the present embodiment. For example, the pressure sensor 10 can detect differential pressures of two fluids. The pressure sensor 10 is not limited to this example but may detect pressure of a single fluid.

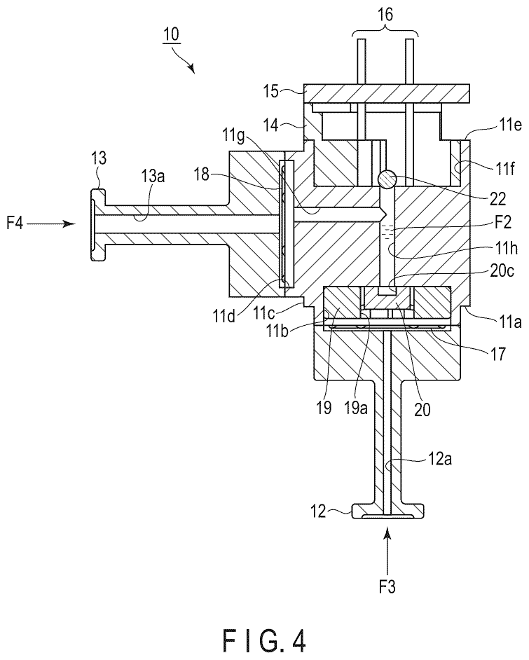

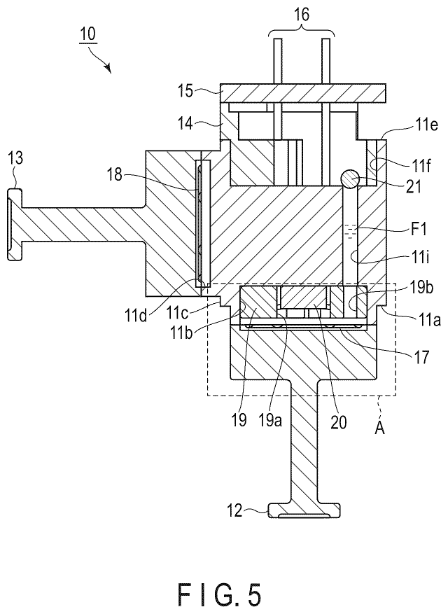

As shown in FIG. 1 to FIG. 3, the pressure sensor 10 includes a base 11, a first port 12 into which a fluid F3 as a measurement target is introduced, a second port 13 into which a fluid F4 as a measurement target is introduced, a spacer 14, a substrate 15, a plurality of lead pins 16, a first diaphragm 17, a second diaphragm 18, an adjustment member 19, a sensor unit 20, a first fluid F1 (shown in FIG. 5) and a second fluid F2 (shown in FIG. 4) as a filler, and the like.

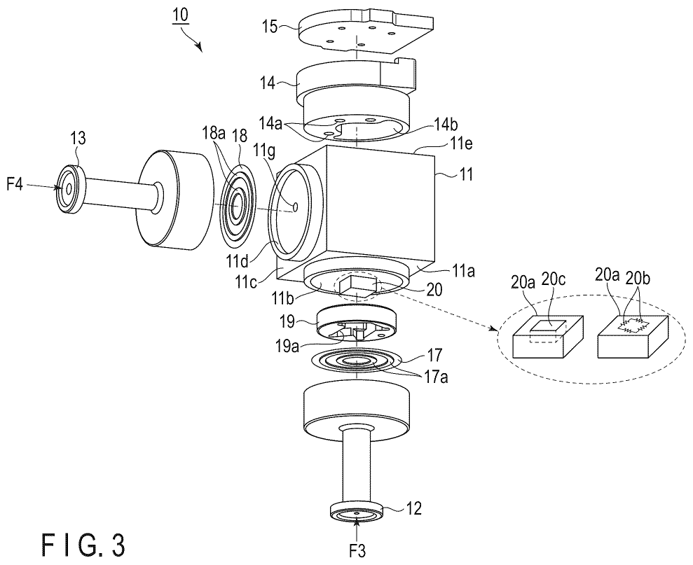

As shown in FIG. 3, the base 11, which is rectangular parallelepiped, is formed of metal material, e.g., stainless steel, or an alloy such as iron, nickel, cobalt, etc., and includes six surfaces, each intersecting one another at right angles. A first cylindrical recess 11b is provided in a first surface 11a of the base 11. The bottom surface of the first recess 11b is located deeper than the first surface 11a. A second recess 11d is provided in a second surface 11c orthogonal to the first surface 11a. The bottom surface of the second recess 11d is located shallower than the second surface 11c. As shown in FIG. 4, a third cylindrical recess 11f is provided in a third surface 11e parallel to the first surface 11a. The bottom surface of the third recess 11f is located deeper than the third surface 11e.

The spacer 14 formed of, for example, an insulating resin is provided inside the third recess 11f. An insulating substrate 15 is attached to the top surface of the spacer 14. As shown in FIG. 3, the spacer 14 has a plurality of holes 14a into which the plurality of lead pins 16 held through the substrate 15 are inserted respectively, and a larger hole 14b into which a plurality of the lead pins 16 are inserted together.

The plurality of lead pins 16 are composed of conductive metal. The plurality of lead pins 16 penetrate from the bottom surface of the third recess 11f of the base 11 to the bottom surface of the first recess 11b through the substrate 15 and the spacer 14. Each of the lead pins 16 in the base 11 is arranged in insulating sheath (not shown) and is electrically insulated from the base 11 by the sheath.

As shown in FIG. 3 and FIG. 4, a pipe-shaped hole 11g is provided in the bottom surface of the second recess 11d. An end of the hole 11g is connected to a middle portion of the pipe-shaped hole 11h provided inside the base 11. An end of the hole 11h is arranged in the center of the bottom surface of the third recess 11f, and the other end is arranged in the center of the bottom surface of the first recess 11b. The hole 11g and the hole 11h constitute a second flow path.

The hole 11g is provided at a position deviated from the center of the second recess 11d. More specifically, the hole 11g is arranged above the center of the second recess 11d.

The first diaphragm 17 is attached around the first recess 11b. The first recess 11b is closed by the first diaphragm 17. More specifically, the surrounding of the first diaphragm 17 is welded to the surrounding of the first recess 11b, and space is formed between the first diaphragm 17 and the first recess 11b.

The second diaphragm 18 is arranged around the second recess 11d. The second recess 11d is closed by the second diaphragm 18. More specifically, the surrounding of the second diaphragm 18 is welded to the surrounding of the second recess 11d. Space is formed between the second diaphragm 18 and the second recess 11d.

The first port 12 is formed of, for example, the same material of the base 11 and includes a hole 12a penetrating from one end to the other end. The other end of the first port 12 is attached to the surrounding of the first recess 11b. More specifically, the surrounding of the other end of the first port 12 is welded to the surrounding of the first recess 11b to cover the first diaphragm 17. The third fluid F3 as a measurement target introduced from one end of the first port 12 is directed to the first diaphragm 17.

The second port 13 is formed of, for example, the same material of the base 11 and includes a hole 13a penetrating from one end to the other end. The other end of the second port 13 is attached to the surrounding of the second recess 11d. More specifically, the surrounding of the other end of the second port 13 is welded to the surrounding of the second recess 11d to cover the second diaphragm 18. The fourth fluid F4 as a measurement target introduced from one end of the second port 13 is directed to the second diaphragm 18.

In the first recess 11b, the sensor unit 20 is provided at a position opposed to the other end of the pipe-shaped hole 11h. As shown in FIG. 3, the sensor unit 20 is constituted by a pedestal 20a and a plurality of strain gages 20 provided on the surface of the pedestal 20a. The pedestal 20a includes a recess 20c at the center portion. The thickness of the center portion is thinner than thickness of the surrounding. Thus, the center portion of the pedestal 20a is deformable. The pedestal 20a is fixed to the bottom surface of the first recess 11b using, for example, adhesive, so that the recess 20c is opposite to the other end of the pipe-shaped hole 11h.

The plurality of the strain gages 20b are arranged at the deformable center portion on a surface opposite to the recess 20c of the pedestal 20a. The plurality of the strain gages 20b constitute a bridge circuit. The bridge circuit detects deformation of the center portion of the pedestal 20a as an electric signal. The configuration of the bridge circuit is not essential in the present embodiment. Thus, the detailed description thereof is omitted. The plurality of strain gages is electrically connected to the plurality of the lead pins 16. An output signal of the bridge circuit is output to the outside of the pressure sensor 10 through the lead pin 16.

In the first recess 11b, the adjustment member 19 is provided around the sensor unit 20 and the plurality of lead pins 16. The adjustment member 19 is formed of an insulating, for example, ceramic. The adjustment member 19 has an outer diameter substantially same as the diameter of the first recess 11b and is fixed to the bottom surface of the first recess 11b using, for example, an adhesive. The adjustment member 19 includes a housing portion 19a as a space for arranging the sensor 20 and the plurality of lead pins 16. The adjustment member 19 adjusts the amount of the first fluid F1 filled in the space formed by the housing portion 19a, the first diaphragm 17, and the first recess 11b.

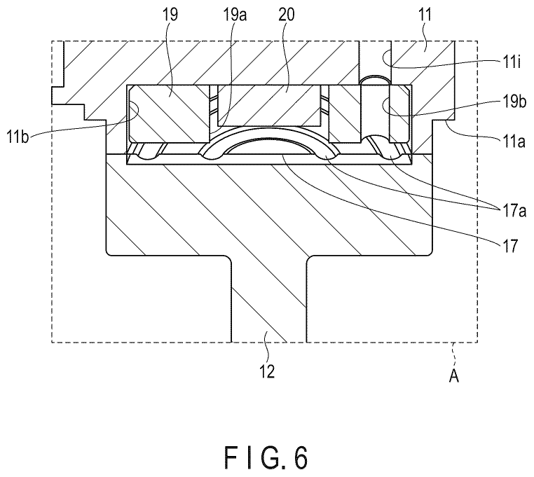

Further, as shown in FIG. 5 and FIG. 6, the adjustment member 19 includes a hole 19b introducing the first fluid F1 into the space. The hole 19b is located at position outer than the center of the adjustment member 19 and opposed to one of plurality of grooves 17a concentrically provided in the first diaphragm 17. More specifically, the hole 19b is arranged to be opposed to the outermost groove 17a among the plurality of grooves 17a.

The base 11 includes a pipe-shaped hole 11i as a first flow path at a position opposed to the hole 19b of the adjustment member 19. One end of the hole 11i is arranged in the bottom surface of the third recess 11f. The other end is arranged at a position opposed to the hole 19b of the adjustment member 19 in the bottom surface of the first recess 11b.

In the above configuration, for example, silicon oil as the first fluid F1 is infused into the hole 11i from the third recess 11f side of the base 11. The silicon oil infused into the hole 11i is infused into the first recess 11b from the hole 19b of the adjustment member 19 and fills the space among the first recess 11b, the first diaphragm 17, the adjustment member 19, the sensor unit 20, and the plurality of lead pins 16. Further, after the hole 19b and the hole 11i of the adjustment member 19 are filled with silicon oil, one end of the hole 11i is sealed by, for example, a metal ball 21. More specifically, the ball 21 is welded to one end of the hole 11i.

In contrast, as shown in FIG. 4, for example, silicon oil as the second fluid F2 is infused into the hole 11h from the third recess 11f side of the base 11. The silicon oil infused into the hole 11h is infused into a recess 20c in the pedestal 20a, the pedestal 20a as the sensor unit 20. Further, the silicon oil infused into the hole 11h is filled into the space formed by the hole 11g, the second recess 11d and the second diaphragm 18. After the hole 11h is filled with the silicon oil, one end of the hole 11h is sealed by, for example, a metal ball 22. More specifically, the ball 22 is welded to one end of the hole 11h.

In the above configuration, when the third fluid F3 as the measurement target is introduced into the first port 12 and the fourth fluid F4 as the measurement target is introduced to the second port 13, the first diaphragm 17 deforms due to pressure by the third fluid F3 and the second diaphragm 18 deforms due to pressure by the fourth fluid F4. The force caused by the deformation of the first diaphragm 17 and second diaphragm 18 is transmitted to the front surface and rear surface of the sensor unit 20 by silicon oil, thus deforming the center portion of the pedestal 20a. In association with the deformation of the center portion of the pedestal 20a, the balance of the bridge circuit is collapsed and the difference between the pressures of the third fluid F3 and the fourth fluid F4 is detected as electric signals from the bridge circuit.

### Advantage of Embodiment

According to the above embodiment, the adjustment member 19 includes the hole 19b introducing the silicon oil, and the base 11 includes the hole 11i at a position opposed to the hole 19b of the adjustment member 19. Therefore, the silicon oil can be filled into the space of the first recess 11b including the adjustment member 19 and the like from the third recess 11f side of the base 11.

Further, the hole 19b of the adjustment member 19 is located in one of the plurality of grooves 17a of the first diaphragm 17, opposed to the outermost groove 17a. Therefore, the silicon oil introduced form the hole 19b can be surely introduced into spaces apart from the hole 19b in a horizontal direction along the grooves 17a of the first diaphragm 17. Therefore, generation of air bubbles due to unfilled the silicon oil can be suppressed. Thus, the degradation in the performance of the pressure sensor can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pressure sensor, comprising:
a base including a first flow path filled with a first fluid and a first recess communicated with the first flow path;
a first diaphragm sealing the first recess;
a sensor unit provided in the first recess; and
an adjustment member arranged around the sensor unit in the first recess, including a hole communicated with the first flow path and introducing the first fluid in the first flow path into the first recess, wherein
the first diaphragm includes a plurality of grooves arranged concentrically, and
the hole is opposed to one of the plurality of grooves.

2. The pressure sensor of claim 1, wherein
the hole of the adjustment member is arranged at a position opposed to an outermost groove of the plurality of grooves.

3. The pressure sensor of claim 1, wherein
the base includes a second recess and a second flow path filled with a second fluid, one end of the second flow path being communicated with the second recess, and another end of the second flow path being communicated with the sensor unit of the first recess.

4. The pressure sensor of claim 3, wherein
the one end of the second flow path is arranged above a center of the second recess.

5. The pressure sensor of claim 4, further comprising:
a first port provided at a position opposed to the first diaphragm of the base, into which a third fluid is introduced;
a second diaphragm sealing the second recess; and
a second port provided at a position opposed to the second diaphragm of the base, into which a fourth fluid is introduced.
